(19) United States
(12) Patent Application Publication
(10) Pub. No.: US 2004/0054707 A1
(43) Pub. Date: Mar. 18, 2004

(54) Multiplication coefficient supplement device, multiplication coefficient supplement method, and multiplication factor supplement program

(76) Inventor: Katsushi Yamada, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/250,493

(22) PCT Filed: May 15, 2002
(86) PCT No.: PCT/JP02/04693

(30) Foreign Application Priority Data
May 15, 2001 (JP) 2001-145198

(51) Int. Cl. G06F 7/52; G06F 17/10

(52) U.S. Cl. 708/620; 708/300

(57) ABSTRACT

The present invention relates to a multiplication coefficient complementary apparatus for complementing a multiplication coefficient while reducing unnecessary operations performed during complementing the multiplication coefficient. The multiplication coefficient complementary apparatus comprises a plurality of multiplication units (11) each for multiplying an input signal by a multiplication coefficient; a plurality of complementary units (12) each for complementing the multiplication coefficient by means of a time constant process; and a control unit (13) for changing states of connecting the multiplication units (11) with the complementary units (12).

### FIELD OF THE INVENTION

The present invention relates to an apparatus for, a method of, and a computer program product for complementing a multiplication coefficient while multiplying an input signal by the multiplication coefficient.

### BACKGROUND OF THE INVENTION

Up until now, there have been provided a wide variety of digital audio apparatuses for carrying out a volume adjusting function by way of multiplying an audio input signal by a multiplication coefficient in response to a volume level specified by a user. Here, as the multiplication coefficient is specified a discrete value determined in response to the volume level specified by the user. It is well known that the digital audio apparatus is operative to complement the multiplication coefficient by means of a time constant process while multiplying the audio input signal by the multiplication coefficient so as to obtain an audio output signal to be converted into a sound smoothly audible to a human ear, thereby eliminating an audible noise occurring due to a discontinuous waveform caused by the multiplication coefficient with the discrete value.

One typical example of the conventional multiplication coefficient complementary apparatus operative to carry out a four-channel volume adjusting function and forming part of the digital audio apparatus is exemplified and shown in FIG. 8. As shown in FIG. 8, the conventional multiplication coefficient complementary apparatus 110 comprises: four multiplication units 21, 22, 23, and 24 each adapted to multiply an audio input signal by a multiplication coefficient; and four complementary units 31, 32, 33, and 34, respectively associated with the multiplication units 21, 22, 23, and 24 in one-to-one relationship, and each adapted to carry out a coefficient complementary operation to complement the multiplication coefficient for a multiplication unit by means of a time constant process.

The complementary unit 31 forming part of the multiplication coefficient complementary apparatus is shown in FIG. 9. As shown in FIG. 9, the complementary unit 31 comprises an input section 31a adapted to input a target value of the multiplication coefficient therethrough, a first multiplication section 31d adapted to multiply the target value of the multiplication coefficient by (1−α), a delay section 31g adapted to delay the multiplication coefficient for one sampling period, and output the multiplication coefficient thus delayed to a delay signal output section 31c, a second multiplication section 31e adapted to input the multiplication coefficient delayed for one predetermined sampling period from the delay signal output section 31c, and multiply the multiplication coefficient delayed for one sampling period by α, and an adding section 31f adapted to add a value outputted from the first multiplication section 31d to a value outputted from the second multiplication section 31e to generate a multiplication coefficient to be outputted to an output section 31b, wherein α is intended to mean a time constant. The conventional complementary unit 31 thus constructed is operative to carry out the aforesaid time constant process in response to the target value of the multiplication coefficient inputted from the input section 31a so to complement the multiplication coefficient from the current value to the target value, and to output the multiplication coefficient thus complemented from the output section 31b to the multiplication unit 21. The four complementary units 31, 32, 33, and 34 are the same in construction as one another, and operative to output the multiplication coefficients to the respective multiplication units 21, 22, 23, and 24.

Making the assumption that the multiplication coefficient is to be changed from, for example, a current value at “1” to a target value at “0” for a first channel, and the input section 31a of the first-channel complementary unit 31 is set at “0” (target value). The multiplication coefficient thus complemented for every sampling period and outputted from the output section 31b of the complementary unit 31 to the multiplication unit 21 is gradually declining from “1” and converging to “0” to form a curve locus gently running in accordance with the time constant α as shown in FIG. 10. The multiplication unit 21 is then operated to multiply the input signal by the multiplication coefficient thus complemented, thereby making it possible to output an audio output signal with a smooth waveform to be converted to a sound smoothly audible to a human ear. The time constant α is a value equal to or greater than “0” but less than “1”. The variation of the multiplication coefficients for every sampling period becomes smaller as the time constant α approaches to “1”, thereby enabling to output an audio output signal with a smooth waveform to be converted to a sound smoothly audible to a human ear while eliminating an audible noise due to a discontinuous waveform resulted from the multiplication coefficient with the discrete values.

The conventional multiplication coefficient complementary apparatus, however, encounters a drawback that the multiplication coefficient complementary apparatus comprises a plurality of multiplication units 21, 22, 23, and 24, and a plurality of complementary units 31, 32, 33, and 34, respectively associated with the multiplication units 21, 22, 23, and 24 in one-to-one relationship, resulting in the fact that the conventional multiplication coefficient complementary apparatus requires the complementary units equal in number to the multiplication units. Furthermore, the conventional multiplication coefficient complementary apparatus encounters another drawback that the complementary units, which have finished the coefficient complementary operation or do not carry out the coefficient complementary operation, are still unnecessarily operating in a converging state. This means that all of the complementary units remain operating continuously for every sampling period regardless of whether carrying out the coefficient complementary operation or not, thereby consuming effective amount of operations for the digital audio apparatus, which can perform only a limited amount of operations.

In view of the foregoing problems, it is an object of the present invention to provide an apparatus for, a method of, and a computer program product for complementing a multiplication coefficient, which can reduce unnecessary operations performed during complementing a multiplication coefficient.

### SUMMARY OF THE INVENTION

In accordance with a first aspect of the present invention, there is provided a multiplication coefficient complementary apparatus comprising: a plurality of multiplication units each for multiplying an input signal by a multiplication coefficient; a plurality of complementary units each for complementing the multiplication coefficient by means of a time constant process; and a control unit for changing states of connecting the multiplication units with the complementary units. This construction makes it possible for the multiplication coefficient complementary apparatus to comprise complementary units less in the number than the multiplication number as well as to reduce unnecessary operations performed during complementing the multiplication coefficient.

In accordance with a second aspect of the present invention, the control unit of the aforesaid multiplication coefficient complementary apparatus may connect a multiplication unit with a complementary unit upon starting to complement the multiplication coefficient. This construction makes it possible for the multiplication coefficient complementary apparatus to comprise only a minimum necessary number of complementary units in order to simultaneously complementing the multiplication coefficients as well as to further reduce unnecessary operations performed during complementing the multiplication coefficient.

In accordance with a third aspect of the present invention, the control unit of the aforesaid multiplication coefficient complementary apparatus is operative to disconnect the multiplication unit from the complementary unit when a predetermined time period elapses after the multiplication unit has been connected with the complementary unit. This construction makes it possible for the multiplication coefficient complementary apparatus to regard complementary units which have been operating for the predetermined time period as having finished their operations, and to connect them with other multiplication units for complementing other multiplication coefficients, thereby preventing the complementary units from being occupied by particular multiplication units as well as further reducing unnecessary operations performed during complementing the multiplication coefficient while maintaining the advantages of the multiplication units.

In accordance with a fourth aspect of the present invention, the control unit of the aforesaid multiplication coefficient complementary apparatus is operative to set the multiplication unit at a target value of the multiplication coefficient after the multiplication unit is disconnected from the complementary unit. This construction makes it possible for the multiplication coefficient complementary apparatus to disconnect the multiplication unit from the complementary unit and set the multiplication unit at the target value of the multiplication coefficient when the multiplication coefficient approaches to a value sufficiently close to the target value, thereby constantly carrying out a volume adjusting function by way of multiplying an audio input signal by the multiplication coefficient, which is equal to the target value, and eliminating an audible noise occurring due to a discontinuous waveform caused by the multiplication coefficient with the discrete values.

In accordance with a fifth aspect of the present invention, there is provided a multiplication coefficient complementary method comprising the steps of: connecting a multiplication unit for multiplying an input signal by a multiplication coefficient; with a complementary unit for complementing the multiplication coefficient by means of a time constant process; and disconnecting the multiplication unit from the complementary unit when a predetermined time period elapses after the multiplication unit has been connected with the complementary unit. This construction enables to reduce unnecessary operations performed during complementing the multiplication coefficient.

In accordance with a sixth aspect of the present invention, the aforesaid multiplication coefficient complementary method further comprises a step of: setting the multiplication unit at a target value of the multiplication coefficient after the multiplication unit is disconnected from the complementary unit. This construction enables to disconnect the multiplication unit from the complementary unit when the multiplication coefficient approaches to a value sufficiently close to the target value, and set the multiplication unit at the target value of the multiplication coefficient, thereby constantly carrying out a volume adjusting function by way of multiplying an audio input signal by the multiplication coefficient, which is equal to the target value, and eliminating an audible noise occurring due to a discontinuous waveform caused by the multiplication coefficient with the discrete values.

In accordance with a seventh aspect of the present invention, there is provided a multiplication coefficient complementary computer program product executable by a computer to perform a function of a control unit for changing states of connecting a plurality of multiplication units with a plurality of complementary units, whereby each of the multiplication units is operative to multiply an input signal by a multiplication coefficient; and each of the complementary units is operative to complement the multiplication coefficient by means of a time constant process. This construction enables to reduce unnecessary operations performed by the computer such as, for example, a digital signal processor, a microprocessor, or the like, during complementing a multiplication coefficient.

In accordance with an eighth aspect of the present invention, there is provided a multiplication coefficient complementary computer program product executable by a computer to perform a set of steps comprising: a step of connecting a multiplication unit for multiplying an input signal by a multiplication coefficient; with a complementary unit for complementing the multiplication coefficient by means of a time constant process; and a step of disconnecting the multiplication unit from the complementary unit when a predetermined time period elapses after the multiplication unit has been connected with the complementary unit. This construction enables to reduce unnecessary operations during complementing a multiplication coefficient.

In accordance with a ninth aspect of the present invention, the aforesaid multiplication coefficient complementary computer program product executable by a computer to perform a set of steps comprises a step of disconnecting the multiplication unit from-the complementary unit when a predetermined time period elapses after the multiplication unit has been connected with the complementary unit. This construction enables to disconnect the multiplication unit from the complementary unit when the multiplication coefficient approaches to a value sufficiently close to the target value, and set the multiplication unit at the target value of the multiplication coefficient, thereby constantly carrying out a volume adjusting function by way of multiplying an audio input signal by the multiplication coefficient, which is equal to the target value and eliminating an audible noise occurring due to a discontinuous waveform caused by the multiplication coefficient with the discrete values.

### BRIEF DESCRIPTION OF THE DRAWINGS

The features and advantages of the multiplication coefficient complementary apparatus, the multiplication coefficient complementing method, and the multiplication coefficient complementing computer program product according to the present invention will more clearly be understood from the following description taken in conjunction with the accompanying drawings in which:

FIG. 1 is a block diagram showing a preferred embodiment of a multiplication coefficient complementary apparatus according to the present invention;

FIG. 2 is a block diagram showing a multiplication unit of the preferred embodiment of the multiplication coefficient complementary apparatus according to the present invention;

FIG. 3 is a block diagram showing a complementary unit of the preferred embodiment of the multiplication coefficient complementary apparatus according to the present invention;

FIG. 4 is a graph showing multiplication coefficient values outputted from the preferred embodiment of the multiplication coefficient complementary apparatus according to the present invention;

FIG. 5 is a flowchart showing a process performed by a first preferred embodiment of the multiplication coefficient complementary apparatus according to the present invention;

FIG. 6 is a block diagram showing a structure of a storage portion for use in a preferred embodiment of a multiplication coefficient complementing computer program product according to the present invention;

FIG. 7 is a flowchart showing a process performed by a second preferred embodiment of the multiplication coefficient complementary apparatus according to the present invention;

FIG. 8 is a block diagram showing a conventional multiplication coefficient complementary apparatus;

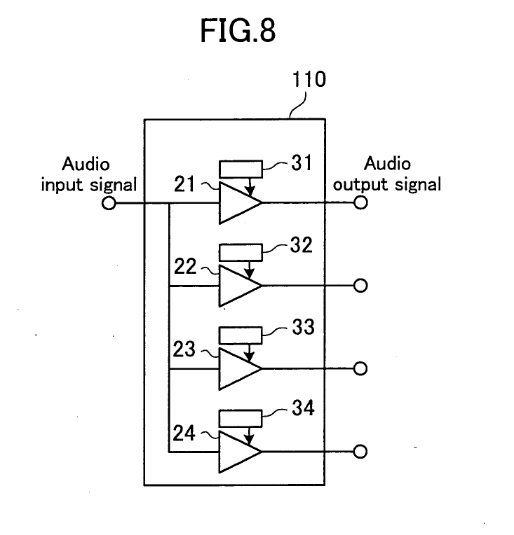

FIG. 9 is a block diagram showing a multiplication unit of the conventional multiplication coefficient complementary apparatus; and

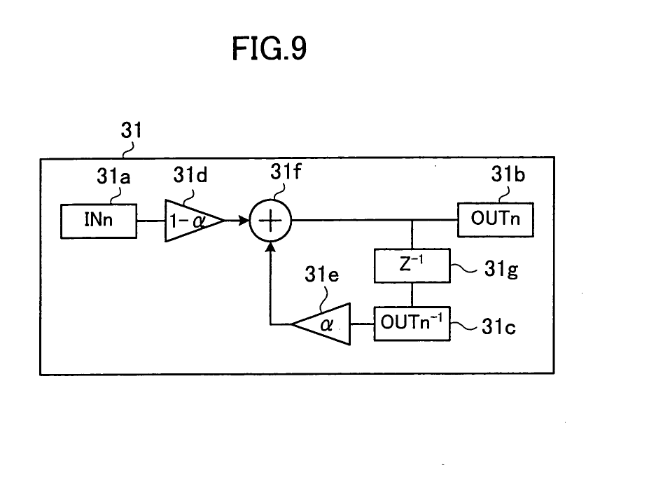

FIG. 10 is a block diagram showing a complementary unit of the conventional multiplication coefficient complementary apparatus.

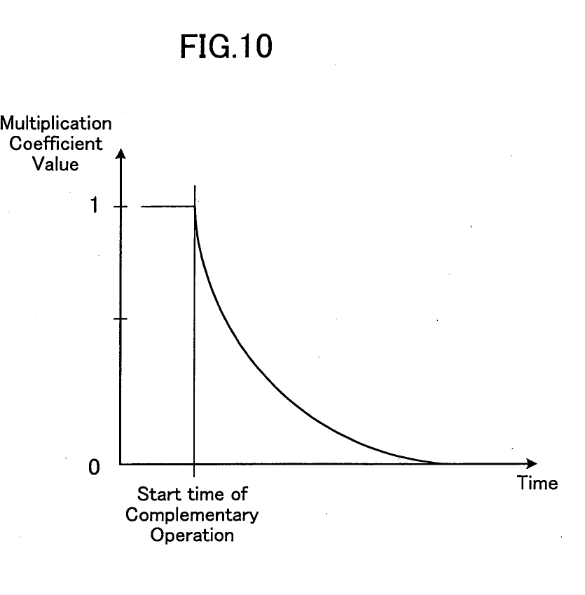

### DESCRIPTION OF THE PREFERRED EMBODIMENTS

Description of the preferred embodiment of the present invention will be made hereinlater with reference to the drawings.

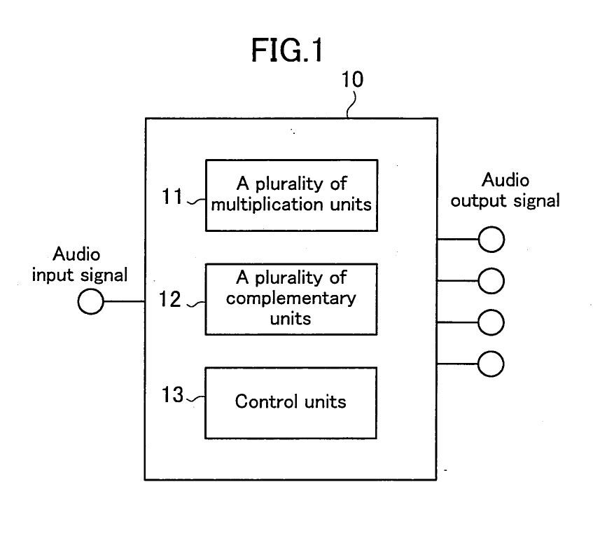

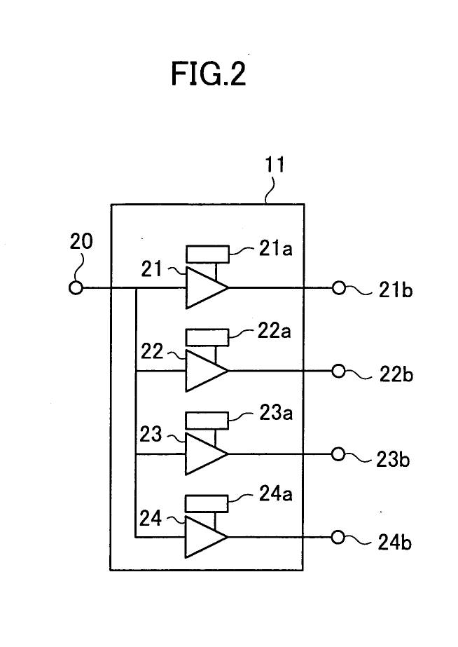

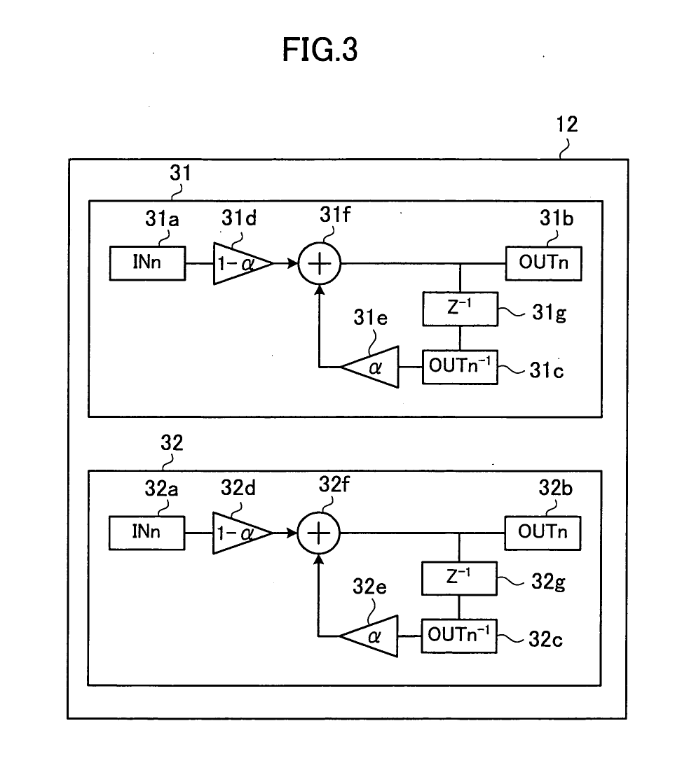

Description hereinlater will be directed to a first preferred embodiment of the multiplication coefficient complementary apparatus according to the present invention. The preferred embodiment of the multiplication coefficient complementary apparatus according to the present invention will now be described with reference to the drawings shown in FIG. 1. The preferred embodiment of the multiplication coefficient complementary apparatus according to the present invention comprises a plurality of multiplication units and a plurality of complementary units. The multiplication units forming part of the preferred embodiment of the multiplication coefficient complementary apparatus according to the present invention are shown in FIG. 2. The complementary units of the preferred embodiment of the multiplication coefficient complementary apparatus according to the present invention are shown in FIG. 3.

The multiplication coefficient complementary apparatus 10 shown in FIG. 1 is mounted on a digital audio apparatus for carrying out a volume adjusting function, as comprising a plurality of multiplication units 11 for multiplying a single-channel input signal by four respective multiplication coefficients to generate a four-channel audio output signal, a plurality of complementary units 12 for complementing the multiplication coefficients by means of a time constant process; and a control unit 13 for changing states of connecting the multiplication units 11 with the complementary units 12.

The multiplication units 11, as a whole constituting a multiplication unit group 11, are shown in FIG. 2 as comprising a four multiplication units (a first multiplication unit 21, a second multiplication unit 22, a third multiplication unit 23, and a fourth multiplication unit 24). The four multiplication units 21, 22, 23, and 24 are the same in construction as one another, and adapted to input a single-channel input signal at an audio signal input 20, and multiply the single-channel input signal by four multiplication coefficients 21a, 22a, 23a, and 24a to generate a four-channel audio output signal, wherein the four multiplication coefficients 21a, 22a, 23a, and 24a, respectively correspond to four channels including a first channel, a second channel, a third channel, and a fourth channel.

The complementary units 12, as a whole constituting a complementary unit group 12, are shown in FIG. 3 as comprising two complementary units (a first complementary unit 31, and a second complementary unit 32). The two complementary units 31 and 32 are the same in construction as each other, and comprise first multiplication sections 31d, 32d for respectively multiplying target values of the multiplication coefficients, inputted from input sections 31a, 32a, by (1−α), second multiplication sections 31e, 32e for respectively inputting multiplication coefficients delayed for one predetermined sampling period from delay signal output sections 31c, 32c, and multiplying the delayed multiplication coefficients by a, adding sections 31f, 32f for respectively adding values outputted from the first multiplication sections 31d, 32d to values outputted from the second multiplication sections 31e, 32e to respectively generate multiplication coefficients to be outputted to output sections 31b, 32b, and delay sections 31g, 32g for respectively delaying the multiplication coefficient for one sampling period, and outputting the multiplication coefficients thus delayed to the delay signal output sections 31c, 32c wherein a is intended to mean a time constant.

It is assumed that the input value (target values of the multiplication coefficients) inputted to the input sections 31a, 32a is IN and the output value (multiplication coefficient after n sample periods) outputted from the 31b, 32 is OUTn. The relationship between IN and OUTn is defined by the following equation (1).

OUTn=IN×(1−α)+OUTn−1×α (Equation 1)

Wherein OUTn−1 is intended to mean the delayed multiplication coefficient, which is one predetermined sampling period behind the multiplication coefficient OUTn. As the time constant α approaches to “1”, the variation of the multiplication coefficients for every sampling period becomes smaller, and accordingly, it takes a longer time until the multiplication coefficient OUTn converges to “0”. As the time constant α, on the other hand, approaches to “0”, the variation of the multiplication coefficients for every sampling period becomes greater, and accordingly, it takes a shorter time until the multiplication coefficient OUTn converges to “0”. It is assumed in the following description, that the time constant α is equal to 0.9, but it is of course needless to mention that the time constant α may be any value equal to or greater than “0” but less than “1”.

When a multiplication coefficient is required to be changed due to an instruction from, for example, a user specifying a volume level, the control unit 13 shown in FIG. 1 is operated to connect a multiplication unit of the multiplication unit group 11 with a complementary unit of the complementary unit group 12 upon starting to complement the multiplication coefficient. The control unit 13 is then operated to disconnect the multiplication unit from the complementary unit when a predetermined time period elapses after the multiplication unit has been connected with the complementary unit. It is assumed in the following description that the control unit 13 is operated to connect, by way of example, the first multiplication unit 21 shown in FIG. 2 and the first complementary unit 31 shown in FIG. 3.

The control unit 13 is operated to set the delay signal output section 31c of the first complementary unit 31 at an initial value of the multiplication coefficient, to set the input section 31a of the first complementary unit 31 at a target value of the multiplication coefficient, and to connect the output section 31b of the first complementary unit 31 with the multiplication coefficient input section 21a of the first multiplication unit 21. Furthermore, the control unit 13 of the present embodiment is operated to disconnect the multiplication coefficient input section 21a of the first multiplication unit 21 from the output section 31b of the first complementary unit 31 when a predetermined time period elapses after the output section 31b of the first complementary unit 31 is connected with the multiplication coefficient input section 21a of the first multiplication unit 21, and the multiplication coefficient approaches to a value sufficiently close to the target value.

The description hereinlater will be directed to the operation of the multiplication coefficient complementary apparatus thus constructed in the case that the multiplication coefficient is to be changed from, for example, a current value at “1” to a target value at “0” for the first-channel complementary unit 31.

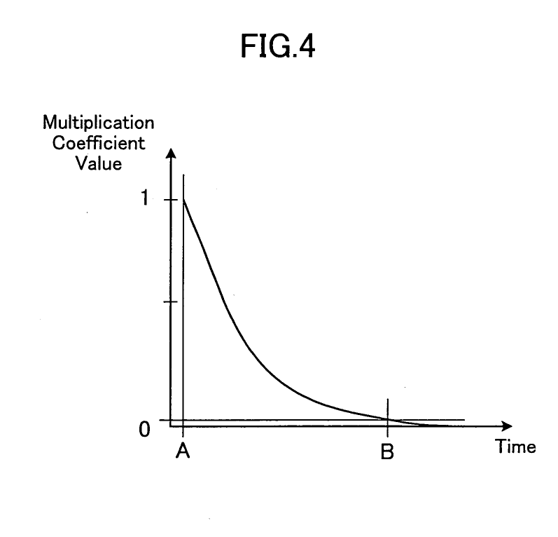

The control unit 13 is then operated to set the delay signal output section 31c of the first complementary unit 31 at an initial value (equal to “1”) of the multiplication coefficient, to set the input section 31a of the first-channel complementary unit 31 at a target value (equal to “0”) of the multiplication coefficient. After the initial value and the target value of the multiplication coefficient are thus specified for the first-channel complementary unit 31, the multiplication coefficient outputted from the output section 31b of the complementary unit 31 is gradually declining from the initial value (equal to “1”) and converging to the target value (equal to “0”) by means of the time constant process carried out by the complementary unit 31 to form a curve locus as shown in FIG. 4.

When one sampling period, for example, elapses, the value of the multiplication coefficient outputted from the complementary unit 31 is calculated in accordance with equation 1 as follows.

0×(1−α)+1×α=α

When two sampling periods elapse, the value of the multiplication coefficient outputted from the complementary unit 31 is calculated in accordance with equation 1 as follows.

0×(1−α)+1×α×α=α²

In a similar manner, when n sampling periods elapse, the value of the multiplication coefficient outputted from the complementary unit 31 results in αⁿ.

The control unit 13 is operated to connect the output section 31b of the first complementary unit 31 with the multiplication coefficient input section 21a of the first multiplication unit 21 shown in FIG. 2 within the same sampling period, in which the control unit 13 specifies the initial value and the target value of the multiplication coefficient for the first-channel complementary unit 31. This leads to the fact that an audio signal outputted from an audio signal output section 21b of the first multiplication unit 21 is changed smoothly in response to the variations of the multiplication coefficient values outputted from the complementary unit 31.

At a time point (point B in FIG. 4) when hundred sampling periods elapse after a time point (point A in FIG. 4) at which the initial value and the target value of the multiplication coefficient are specified for the first-channel complementary unit 31, the value of the multiplication coefficient results in α₁₀₀=0.000026, which can be approximately regarded as the target value (equal to “0”). At this time point, the control unit 13 is operated to disconnect the multiplication coefficient input section 21a of the first multiplication unit 21 from the output section 31b of the first complementary unit 31. The operation of the first complementary unit 31 becomes unnecessary until the multiplication coefficient is required to be changed again due to an instruction from, for example, a user specifying another volume level. While it has been described in the above that the control unit 13 disconnects the first multiplication unit 21 from the first complementary unit 31 when the time period of hundred sampling periods elapses after the multiplication unit 21 has been connected with the complementary unit 31, the time period required to elapse after the multiplication unit 21 has been connected with the complementary unit 31 until the first multiplication unit 21 is disconnected from the first complementary unit 31 is not limited to the hundred sampling periods. According to the present invention, the time period required to elapse after the multiplication unit 21 has been connected with the complementary unit 31 until the first multiplication unit 21 is disconnected from the first complementary unit 31 may be a time period required to elapse after the multiplication unit 21 has been connected with the complementary unit 31 until the value of the multiplication coefficient approaches to the value, approximately equal to the target value, and determined in accordance with the time constant α.

The operations of the first complementary unit 31 in the case that the multiplication coefficient is to be changed from, for example, a current value at “1” to a target value at “0” for the second-channel, the third-channel, and the fourth-channel are the same as that in the case that the multiplication coefficient is to be changed from for the first-channel except for the fact that the output section 31b of the complementary unit 31 is connected with a different multiplication unit, thereby leading to the fact that the complementary unit 31 can complement the multiplication coefficients for four channels.

The multiplication coefficient, for example, for another channel, is required to be complemented while the first complementary unit 31 is complementing the multiplication coefficient for the first channel, the control unit 13 may control the second complementary unit 32 so as to complement the multiplication coefficient for the channel in a similar manner as described above, thereby enabling to simultaneously complement the multiplication coefficients for two channels.

The multiplication coefficients, for example, for more than three channels are required to be complemented, the multiplication coefficient complementary apparatus may complement the multiplication coefficients in a time division process.

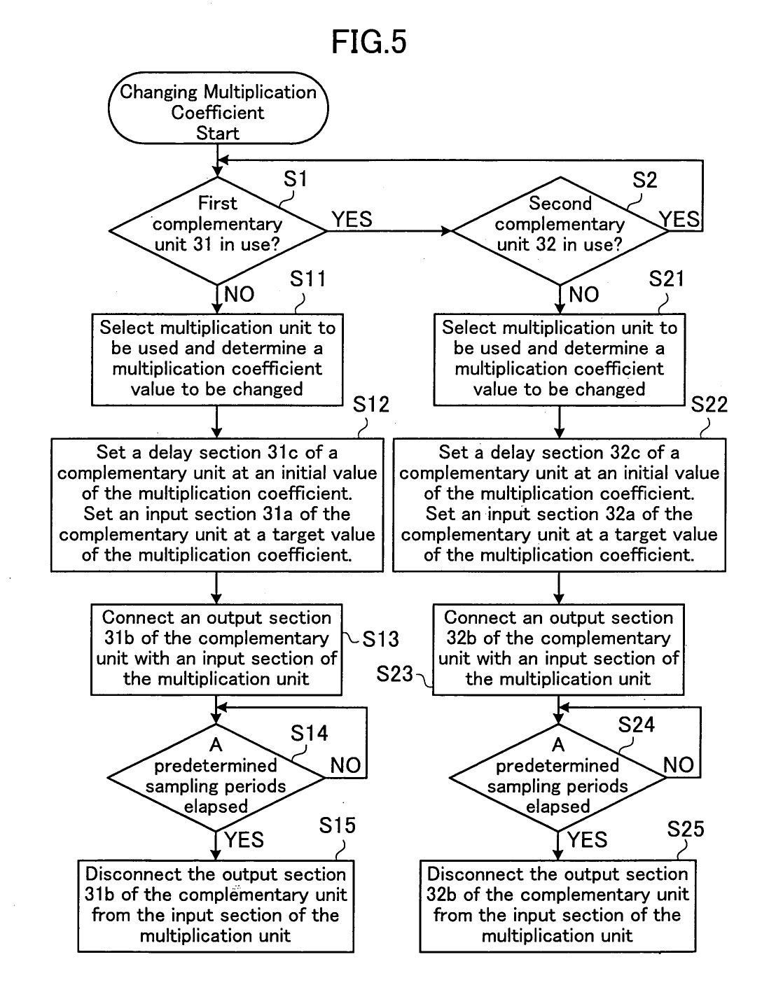

Description hereinlater will be directed to a first preferred embodiment of the multiplication coefficient complementary method according to the present invention with reference to the flowchart shown in FIG. 5. The flowchart appearing in FIG. 5 shows steps of the first preferred embodiment of the multiplication coefficient complementary method according to the present invention.

When a multiplication coefficient is required to be changed due to an instruction from, for example, a user specifying another volume level, the control unit 13 is operated to judge whether the first complementary unit 31 is in use or not (S1). If it is judged that the first complementary unit 31 is in use, the control unit 31 is operated to judge whether the second complementary unit 32 is in use or not (S2). If it is judged that both the first complementary unit 31 and the second complementary unit 32 are in use, the control unit 31 is operated to wait until either of the complementary units has finished its operation.

When it is judged that either of the complementary units is not in use, the first control unit 31 is operated to select a multiplication unit to be used and determine a value of the multiplication coefficient to be changed (S11, S21). The description hereinlater will be directed to the operation in the case that the first complementary unit 31, for example, is used to change the value of multiplication coefficient for the first multiplication unit 21. The control unit 13 is operated to set a delay signal output section 31c of a first complementary unit 31 at an initial value of the multiplication coefficient and to set an input section 31a of the first complementary unit 31 at a target value of the multiplication coefficient (S12). The control unit 13 is then operated to connect an output section 31b of the first complementary unit 31 with an input section 21a of the first multiplication unit 21 (S13). The control unit 13 is operated to wait until predetermined sampling periods elapse, which are determined by the time constant α, after the first complementary unit 31 has been connected with the first multiplication unit 21 (S14), and to disconnect the output section 31b of the complementary unit from the input section 21a of the multiplication unit 21 (S15).

The operation in the case that the second complementary unit 32 is used to change the value of multiplication coefficient is similar to that in the case that the first complementary unit 31 is used except for the fact that the complementary unit 32 is not identical to the complementary unit 31 (S21 to S25).

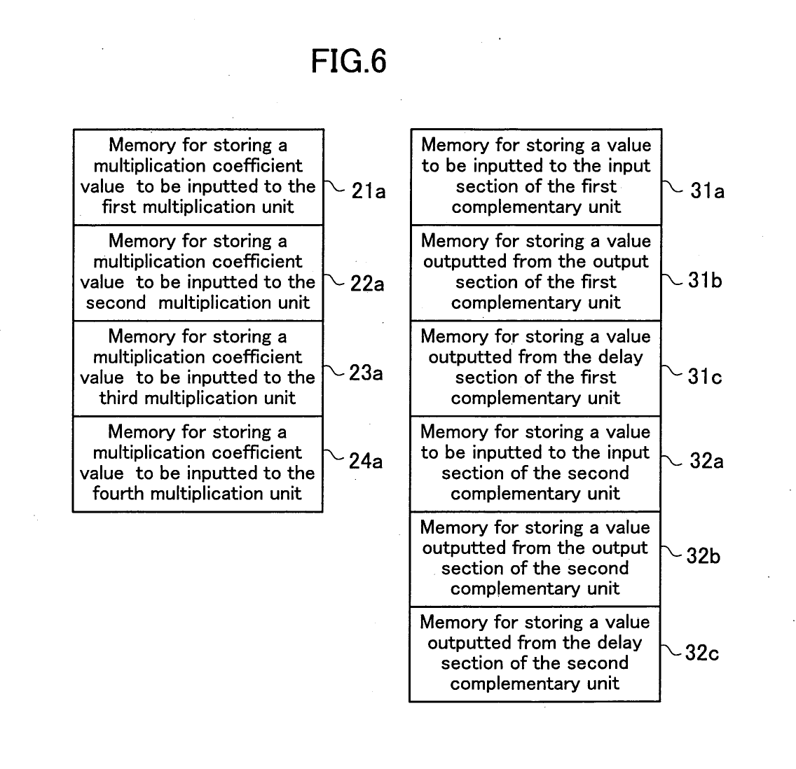

Description hereinlater will be directed to a first preferred embodiment of the multiplication coefficient complementary computer program product according to the present invention with reference to the drawings shown in FIG. 6. The block diagram appearing in FIG. 6 shows a structure of a storage portion for use in the preferred embodiment of a multiplication coefficient complementing computer program product according to the present invention.

The multiplication coefficient complementary computer program product is executable by a computer such as, for example, a digital signal processor, a microprocessor computer, or the like, to perform a function of a control unit for changing states of connecting a plurality of multiplication units with a plurality of complementary units whereby each of the multiplication units is operative to multiply an input signal by a multiplication coefficient; and each of the complementary units is operative to complement the multiplication coefficient by means of a time constant process. As shown in FIG. 6, the computer such as, for example, a digital signal processor, a microprocessor computer, or the like, comprises a storage portion including memories 21a, 22a, 23a, and 24a for storing multiplication coefficient values to be inputted to the respective multiplication units, memories 31a and 32a for storing values to be inputted to the input sections of the respective complementary units, memories 31b and 32b for storing values outputted from the output sections of the respective complementary units, and memories 31c and 32c storing values outputted from the delay sections of the respective complementary unit.

The multiplication coefficient complementary computer program product is executable by a computer to perform the coefficient complementary operation as described in the above with reference to the drawings shown in FIG. 5. The computer is operated to write the value stored in the memory 31b into the memory 21a while connecting the first complementary unit 31 with the first multiplication unit 21 (S13 in FIG. 5).

From the foregoing description, it is to be understood that the multiplication coefficient complementary method according to the present invention, makes it possible for the apparatus comprising, for example, four multiplication units, for carrying out a four-channel volume adjusting function, to complement the multiplication coefficients and output an audio output signal with a smooth waveform, with only two complementary units, which are less in the number than the multiplication units by two, as well as to reduce unnecessary operations performed during complementing a multiplication coefficient, in comparison with the apparatus comprising multiplication units and the complementary units, which are the same in the number as the multiplication units.

Description hereinlater will be directed to a second preferred embodiment of the multiplication coefficient complementary apparatus according to the present invention with reference to the drawings shown in FIGS. 1, 2, and 3. The present embodiment is different from the first embodiment in that the present embodiment of the multiplication coefficient complementary apparatus is operative to directly set the multiplication unit at a target value of the multiplication coefficient after the multiplication unit is disconnected from the complementary unit. The elements and the parts of the second embodiment entirely the same as those of the first embodiment will be omitted from description for avoiding repetition.

At the time point (point B in FIG. 4) when the hundred sampling periods elapse after a time point at which the multiplication unit is connected with the complementary unit, and the multiplication unit is disconnected from the complementary unit, the value of the multiplication coefficient outputted from the output section 31b of the complementary unit 31 to the multiplication coefficient input section 21a of the first multiplication unit 21 results in α¹⁰⁰=0.000026, which can be approximately regarded equal to the target value (equal to “0”). The present embodiment of the multiplication coefficient complementary apparatus is operative to set the multiplication coefficient input section 21a of the first multiplication unit 21 at the target value (equal to “0”) after the multiplication unit is disconnected from the complementary unit so that the value of the multiplication coefficient becomes completely equal to the target value (equal to “0”). At the time point when the hundred sampling periods elapse after the time point at which the multiplication unit is connected with the complementary unit, the value of the multiplication coefficient outputted from the output section 31b of the complementary unit 31 to the multiplication coefficient input section 21a of the first multiplication unit 21 results in α¹⁰⁰=0.000026, which can be approximately regarded as the target value (equal to “0”). As will be seen from the foregoing description, the present embodiment of the multiplication coefficient complementary apparatus, which is operative to directly set the multiplication coefficient input section 21a of the first multiplication unit 21 at the target value (equal to “0”) when the multiplication unit is disconnected with the complementary unit, does not output an output signal with a discontinuous waveform causing an audible noise to a human ear, thereby eliminating an audible noise occurring due to a discontinuous waveform caused by the multiplication coefficient with the discrete values.

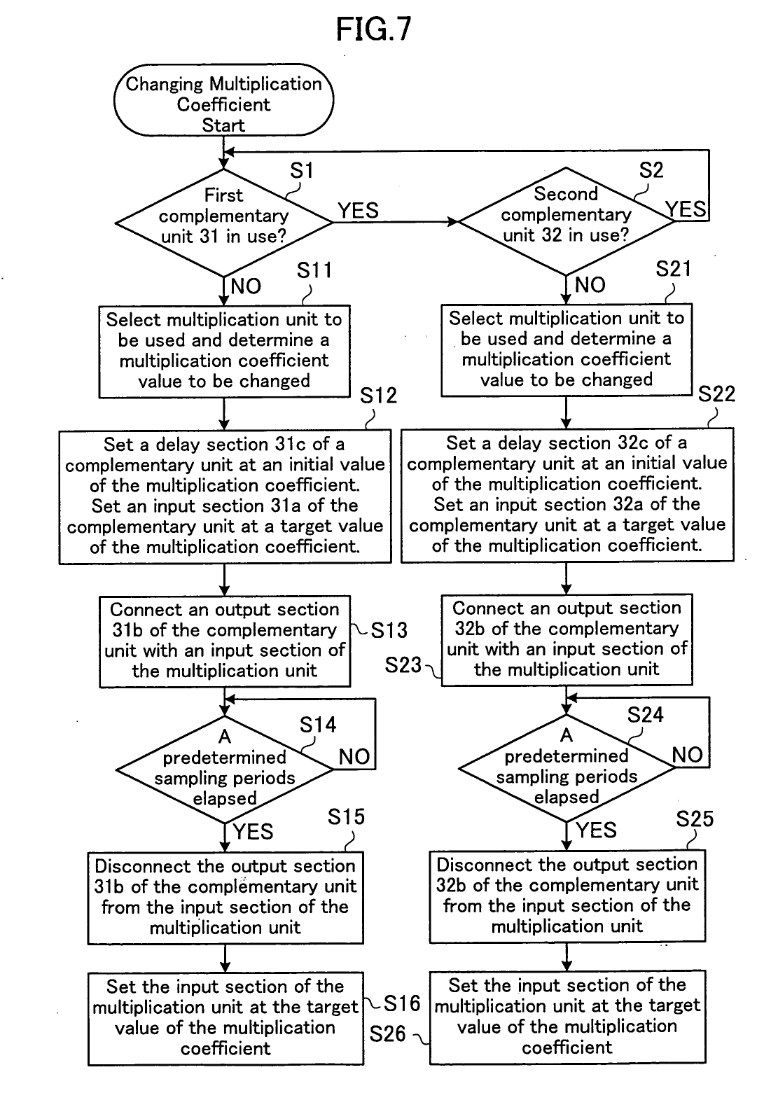

Description hereinlater will be directed to a second preferred embodiment of the multiplication coefficient complementary method according to the present invention with reference to the flow chart shown in FIG. 7. The flow chart appearing in FIG. 7 shows steps of the second preferred embodiment of the multiplication coefficient complementary method according to the present invention.

The present embodiment is different from the first embodiment in that the present embodiment of the multiplication coefficient complementary method has a step of directly setting the multiplication unit at a target value of the multiplication coefficient after the multiplication unit is disconnected from the complementary unit (S16, S26). The other steps of the second embodiment entirely the same as those of the first embodiment will be thus omitted from description for avoiding repetition.

Description hereinlater will be directed to a second preferred embodiment of the multiplication coefficient complementary computer program product according to the present invention with reference to the drawings shown in FIG. 6. The block diagram appearing in FIG. 6 shows a structure of a storage portion for use in the preferred embodiment of a multiplication coefficient complementing computer program product according to the present invention. The present embodiment is different from the first embodiment in that the present embodiment of the multiplication coefficient complementary computer program product is executable by a computer to perform a step of directly setting the multiplication unit at a target value of the multiplication coefficient after the multiplication unit is disconnected from the complementary unit. The computer is operated to write the target value into the memories 21a, 22a, 23a, and 24a while setting the multiplication unit at a target value of the multiplication coefficient. The other steps of the second embodiment entirely the same as those of the first embodiment will be thus omitted from description for avoiding repetition.

As will be seen from the foregoing description, it is to be understood that the present embodiment can constantly carry out a volume adjusting function by way of multiplying an audio input signal by a multiplication coefficient, which is equal to the target value corresponding to a volume level specified by a user, and eliminate an audible noise occurring due to a discontinuous waveform caused by the multiplication coefficient with a discrete value.

While it has been described in the above that the multiplication coefficient complementary apparatus is mounted on a digital audio apparatus, and is operative to input a single-channel input signal and to carry out a four-channel volume adjusting function, according to the present invention, the numbers of channels, the multiplication units, and the complementary units are not limited to the numbers described above, and the number of complementary units may be less than that of the multiplication units.

As will be seen from the foregoing description, it is to be understood that the multiplication coefficient complementary apparatus, the multiplication coefficient complementary method, and the multiplication coefficient complementary computer program product according to the present invention can reduce unnecessary operations performed during complementing a multiplication coefficient while the number of the complementary units may be less than that of the multiplication units.

What is claimed is:

1. A multiplication coefficient complementary apparatus comprising: a plurality of multiplication units each for multiplying an input signal by a multiplication coefficient; a plurality of complementary units each for complementing said multiplication coefficient by means of a time constant process; and a control unit for changing states of connecting said multiplication units with said complementary units.

2. A multiplication coefficient complementary apparatus as set forth in claim 1, in which said control unit is operative to connect a multiplication unit with a complementary unit upon starting to complement said multiplication coefficient.

3. A multiplication coefficient complementary apparatus as set forth in claim 2, in which said control unit is operative to disconnect said multiplication unit from said complementary unit when a predetermined time period elapses after said multiplication unit has been connected with said complementary unit.

4. A multiplication coefficient complementary apparatus as set forth in claim 3, in which said control unit is operative to set said multiplication unit at a target value of said multiplication coefficient after said multiplication unit is disconnected from said complementary unit.

5. A multiplication coefficient complementary method comprising the steps of: connecting a multiplication unit with a complementary unit; and disconnecting said multiplication unit from said complementary unit when a predetermined time period elapses after said multiplication unit has been connected with said complementary unit, whereby said multiplication unit is operative to multiply an input signal by a multiplication coefficient, and said complementary unit is operative to complement said multiplication coefficient by means of a time constant process.

6. A multiplication coefficient complementary method as set forth in claim 5 further comprising a step of: setting said multiplication unit at a target value of said multiplication coefficient after said multiplication unit is disconnected from said complementary unit.

7. A multiplication coefficient complementary computer program product executable by a computer to perform a function of a control unit for changing states of connecting a plurality of multiplication units with a plurality of complementary units, whereby each of said multiplication units is operative to multiply an input signal by a multiplication coefficient; and each of said complementary units is operative to complement said multiplication coefficient by means of a time constant process.

8. A multiplication coefficient complementary computer program product executable by a computer to perform a set of steps comprising: a step of connecting a multiplication unit with a complementary unit; and a step of disconnecting said multiplication unit from said complementary unit when a predetermined time period elapses after said multiplication unit has been connected with said complementary unit, whereby said multiplication unit is operative to multiply an input signal by a multiplication coefficient, and said complementary unit is operative to complement said multiplication coefficient by means of a time constant process

9. A multiplication coefficient complementary computer program product as set forth in claim 8, said computer program product executable by a computer to perform a set of steps comprising: a step of disconnecting said multiplication unit from said complementary unit when a predetermined time period elapses after said multiplication unit has been connected with said complementary unit.
